(19) United States
(12) Patent Application Publication
(10) Pub. No.: US 2008/0164436 A1
(43) Pub. Date: Jul. 10, 2008

(54) Brine valve

(75) Inventor: Christopher T. Hughes, Columbus, OH (US)

Correspondence Address: MUELLER AND SMITH, LPA;MUELLER-SMITH BUILDING, 7700 RIVERS EDGE DRIVE, COLUMBUS, OH, 43235, US

(73) Assignee: Wm. R. Hague, Inc., Coal Grove, OH (US)

(21) Appl. No.: 11/650,030

(22) Filed: Jan. 5, 2007

(51) Int. Cl. F16K 1/32

(52) U.S. Cl. 251/214

(57) ABSTRACT

A brine valve includes a housing having a first port, a second port, and a piston port. The piston port is fitted with a water-sealing diaphragm. An external piston has a first end and a second end. The external piston second end pushes against the diaphragm. An apertured cap affixes over the piston port to retain the external piston in place. The external piston first end extends outside of the apertured cap. An internal piston is disposed within the housing and has a first end and a second end. The internal piston first end pushes against the diaphragm and against the external piston. A seal ring is disposed towards the second end and is fitted to seal the first port. A spring is placed against the internal piston second end. Pushing on the external piston first end moves both pistons to permit water to flow between the housing first and second ports.

### CROSS-REFERENCE TO RELATED APPLICATIONS

None

### STATEMENT REGARDING FEDERALLY SPONSORED RESEARCH

Not applicable.

### BACKGROUND

The present invention relates to water treatment systems, sometimes commonly known as “water softening systems” or simply “water softeners”, and more particularly to a unique bypass water valve or brine valve for use with such systems.

Resin-type ion exchange devices have many uses, such as the softening of water. As the water to be processed is passed through the resin-filled tank, ions in the fluid to be processed, e.g., calcium, are exchanged with ions found in the resin, e.g., sodium, thereby removing objectionable ions found in the water. During this ion exchange process, the ability of the resin to exchange ions gradually is reduced. That is, the resin bed becomes exhausted and, thereafter, water will flow therethrough in unprocessed form.

The capacity of the ion exchange resin bed can be determined from the volume of resin used and the particular type of resin. The concentration of contaminant(s) in the water to be processed can be determined, at least on an average basis. Thus, the volume of water that can be processed by a particular water treatment unit is known. Once that capacity of water has been treated, the bed must be regenerated.

Regeneration of the ion exchange resins typically involves chemically replacing the objectionable ions from the resin with less objectionable ions, e.g., replacing calcium with sodium ions. This regeneration process requires the suspension of the treatment process; thus, necessitating the water to bypass the ion exchange resin tank. At the same time as the ion exchange resin is regenerated, the bed can be backwashed in order to remove trapped particulate matter, the resin tank can be rinsed to remove objectionable soluble materials, an application of sterilization agent to prevent bacterial growth can be accomplished, etc. All of these operations are known in the art.

Water flow between the resin bed and the regenerating or salt bed is controlled by a brine valve, which as its name implies, must have the ability to divert brine from the salt bed into and through the resin bed to reactivate or regenerate it.

It is an improved brine valve that the present invention is directed.

### BRIEF SUMMARY

A brine valve includes a housing having a first port, a second port, and a piston port. The piston port is fitted with a water-sealing diaphragm. An external piston has a first end and a second end. The external piston second end pushes against the diaphragm. An apertured cap affixes over the piston port to retain the external piston in place. The external piston first end extends outside of the apertured cap. An internal piston is disposed within the housing and has a first end and a second end. The internal piston first end pushes against the diaphragm and against the external piston. A seal ring is disposed towards the second end and is fitted to seal the first port. A spring is placed against the internal piston second end. Pushing on the external piston first end moves both pistons to permit water to flow between the housing first and second ports.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a perspective view of the brine valve;

FIG. 2 is an exploded view of the components of the brine valve of FIG. 1;

FIG. 3 is a cross-sectional view taken along line 3-3 of FIG. 1 with the brine valve in a closed position; and

FIG. 4 is a cross-sectional view taken along line 3-3 of FIG. 1 with the brine valve in an open position.

The drawings will be described in further detail below.

### DETAILED DESCRIPTION

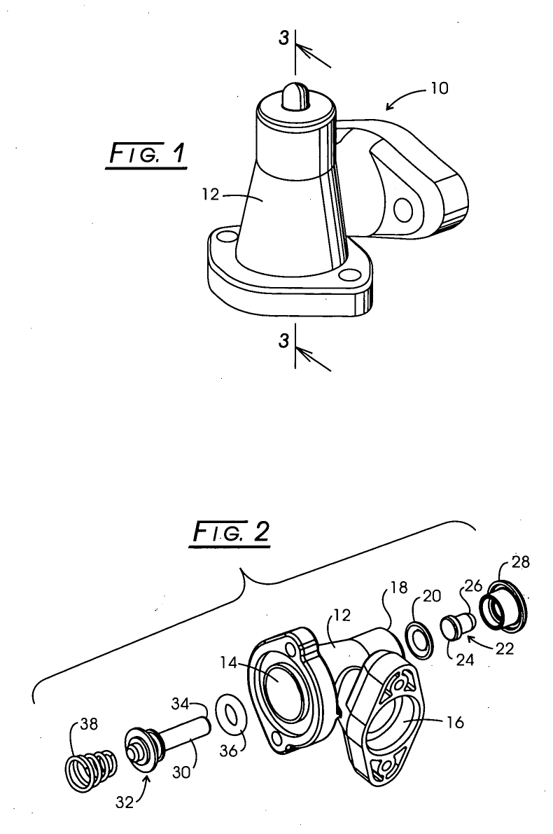

The disclosed brine valve is designed to permit brine water to flow from a brine tank into and through a resin bed. Importantly, the disclosed brine valve is designed with a simple, reliable, yet inexpensive sealing system to prevent water leakage. FIG. 1 illustrates the disclosed brine valve, 10, in perspective view. A components list of brine valve 10 as further shown in FIG. 2 is listed below:

COMPONENTS LIST

| Item Number | Item Description |
|---|---|
| 10 | Brine valve |
| 12 | Housing |
| 14 | Housing first port |
| 16 | Housing second port |
| 18 | Housing piston port |
| 20 | Diaphragm |
| 22 | External piston |
| 24 | External piston first end |
| 26 | External piston second end |
| 28 | Apertured cap |
| 30 | Internal piston |
| 32 | Internal piston first end |
| 34 | Internal piston second end |
| 36 | Valve O-ring |
| 38 | Spring |
| 40 | Housing interior cavity |

Housing 12 has three ports, to wit: a housing first port, 14; a housing second port, 16; and a housing piston port, 18. Sealing housing piston port 18 is a diaphragm, 20, which fits over piston port 18. An external piston, 22, having an external piston first end, 24, and an external piston second end, 26, is adapted and configured for its first end 24 to be received into housing piston port 18 and be in engagement with diaphragm 20. External piston 22 is retained in position by an apertured cap, 28, which is adapted to be fitted over housing piston port 18 and exert pressure on diaphragm 20 to ensure its sealing engagement with housing 12 for sealing the interior of housing 12 from the outside to prevent leaking any water or brine from the interior of housing 12 to the outside. While cap 28 can be secured to housing 12 by a screwing, press fitting, or other technique, welding cap 28 to housing 12 ensures the sealing of diaphragm 20 in position, as described and illustrated herein. Given that the structural components of brine valve 10 desirably are manufactured from plastic, a variety of “welding” techniques can be used, such as, for example, adhesive, laser welding, and the like. Finally, external piston second end 26 is designed to be engaged by a cam lobe (not shown), as will be further described below.

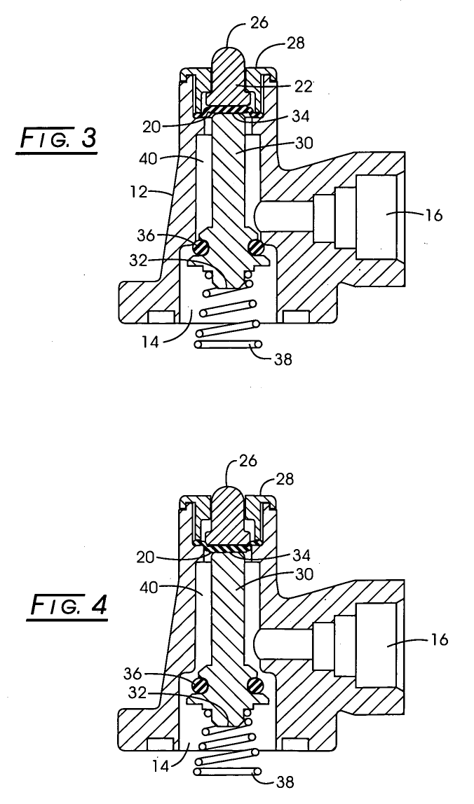

An internal piston, 30, having an internal piston first end, 32 and an internal piston second end, 34, is designed to fit through a valve O-ring, 36, and into housing first port 14 and be retained in position by an annular land located about internal piston first end 32. O-ring 36 is retained within a race formed about the exterior surface of internal piston 30. A spring, 38, fits up against internal piston 30 to hold it in sealing engagement against O-ring 36 with internal piston second end pushing against external piston first end with the aid of spring 38, as illustrated in FIGS. 3 and 4. As also illustrated in FIGS. 3 and 4, spring 38 pushes internal piston 30 to urge it against O-ring 36 for maintaining their sealing engagement.

FIG. 3 in particular illustrates brine valve 10 in a valve closed position where water and/or brine is prevented from flowing between first port 14 and second port 16. In the valve-closed position, O-ring 36 restricts water/brine flow while diaphragm 20 prevents any water/brine leaking to the outside of brine valve 10.

In FIG. 4, brine valve 10 is shown in a open position by a cam lobe (not shown) pushing against external piston second end causing external piston 22 to move downwardly against internal valve second end causing internal piston 30 in turn to move downwardly against spring 38 and moving O-ring 36 from sealing engagement with housing 12 and permitting water/brine to flow between ports 14 and 16 via a housing interior cavity, 40, of housing 12. When the cam lobe moves from contacting relationship with external piston second end, spring 38 re-asserts pressure against internal piston 30 to once again establish the water-tight seal of O-ring 36.

While the invention has been described with reference to various embodiments, those skilled in the art will understand that various changes may be made and equivalents may be substituted for elements thereof without departing from the scope and essence of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. A brine valve, which comprises:
(a) a housing having a first port, a second port, and a piston port;
(b) an external piston having a first end and a second end and disposed in said piston port;
(c) an apertured cap affixed over said piston port to retain said external piston in place, said external piston first end extending outside of said apertured cap;
(d) a water-sealing diaphragm interposed between said housing and said apertured cap to seal said piston port;
(e) an internal piston disposed within said housing and having a first end and a second end, said first end pushing against said external piston second end, and a seal ring disposed towards said second end and fitted to seal said first port; and
(e) a spring placed against said internal piston second end,
whereby pushing on said external piston first end moves both said pistons to permit water to flow between said housing first and second ports.

2. The brine valve of claim 1, wherein said housing, said apertured cap, and said pistons are formed from plastic.

3. The brine valve of claim 2, wherein said apertured cap is welded to said housing.
